(19) United States
(12) Patent Application Publication
(10) Pub. No.: US 2006/0232762 A1
(43) Pub. Date: Oct. 19, 2006

(54) Optical element, measuring apparatus and measuring method

(75) Inventor: Hannu Ensio Jokinen, Oulunsalo (FI)

Correspondence Address: Leon Nigohosian, Jr.;Specialty Minerals Inc./Minteg International Inc., 1 Highland Avenue, Bethlehem, PA, 18017-9482, US

(73) Assignee: Specialty Minerals (Michigan) Inc.

(21) Appl. No.: 11/107,240

(22) Filed: Apr. 15, 2005

(51) Int. Cl. G01C 3/08

(52) U.S. Cl. 356/5.01; 356/5.14

(57) ABSTRACT

The optical element comprises a beam transformer and at least two non-reciprocal components for propagation-direction-dependent polarization operations such that an entrance aperture of the transmission direction, a common two-directional aperture for an exit in the transmission direction and for an entrance in the reception direction, and an exit aperture of the reception direction can be used in the beam transformer. The beam transformer both transmits an optical beam towards an object and receives the reflected optical beam through the common aperture. The beam transformer outputs the received optical beam through the exit aperture of the reception direction different from the entrance aperture of the transmission direction.

The invention relates to an optical element, a measuring apparatus and a measuring method.

A distance measuring apparatus can be a range finder based on a time-of-flight principle with two separate optical axes, a first axis for transmission and a second axis for reception. A laser of the measuring apparatus transmits an optical beam through the first axis furnished with a suitable optical arrangement towards a desired object and an optical beam reflected from the object is received through the second optical axis furnished with a suitable optical arrangement for receiving. The duration for an optical signal to travel from the measuring apparatus to the object and back can be measured and the measured result can be transformed into distance on the basis of the speed of light. In time-of-flight method, e.g. using pulsed laser beam or amplitude modulated continuous laser beam, a characteristic shape of the signal determines the time point being used in the calculation of the time difference and distance value.

Because of the two separate optical axes, the coverage area of the transmitted beam on the object is different from the coverage area, which is observed through the second axis by the receiver. The difference in the coverage areas results in a loss of optical power in the measurement and in a low signal-to-noise ratio. The structure of the optical system also becomes complicated. For example, two objective lenses are needed, one for transmission and one for reception, and that makes the measuring head large. These are particularly serious problems in measuring vessels for hot-steel processing.

To avoid the problems related to the separate optical axes, an arrangement utilizing partially reflecting and transmitting beam splitters have been proposed. In a usual case, the beam splitters may transmit 50 percent and reflect 50 percent. The arrangement combines the optical axes in the transmission and the reception directions for a co-axial operation. There are, however, problems related to this solution, too. These kinds of beam splitters waste optical power when splitting the beam. In the transmission direction, 50 percent at the maximum of optical power can be directed to the object through the co-axial arrangement and 50 percent at the maximum of optical power directed to the object can be received through the co-axial arrangement. Hence, if it is considered that all power of the optical beam transmitted is reflected back, the theoretical maximum performance efficiency is only 25 percent (=50 percent·50 percent) which typically denotes a worse operation than with the two optical axes. Utilizing a linear polarized source, a polarizing beam splitter may transmit nearly 100 percent of the optical beam, but only 50 percent can be received at the detector and the other 50 percent travels back to the source.

### SUMMARY OF THE INVENTION

An object of the invention is to provide an improved optical element, measuring apparatus and measuring method. According to an aspect of the invention, there is provided an optical element for a measuring apparatus configured to transmit an optical beam towards an object in a transmission direction through the optical element, and to receive an optical beam reflected from the object in a reception direction through the optical element. The optical element includes a beam transformer having an entrance aperture of the transmission direction, a common two-directional aperture for an exit in the transmission direction and for an entrance in the reception direction, and an exit aperture of the reception direction. The beam transformer is configured to form at least two internal optical channels supporting different plane-polarization directions, the internal optical channels being common to the transmission and reception directions. The optical element has at least two non-reciprocal components for propagation-direction-dependent polarization operations, and in the transmission direction. The beam transformer is configured to split the optical beam input through the entrance aperture of the transmission direction into plane-polarized beams and to pass the plane-polarized beams to the optical channels. The at least two non-reciprocal components, one for each plane polarized beam in the optical channels, are configured to perform a first propagation-direction-dependent operation on the plane-polarized beams. The beam transformer is configured to combine the optical beams from the optical channels into a transmission beam and to transmit the transmission beam through the common aperture; and in the reception direction. The beam transformer is configured to split the optical beam received through the common aperture into plane-polarized beams and to pass the plane-polarized beams to the optical channels, each non-reciprocal component is configured to perform a second propagation-direction-dependent operation on the plane-polarized beams in the optical channels. The beam transformer is configured to combine the plane-polarized beams from the optical channels into one received optical beam, and to output the received optical beam through the exit aperture of the reception direction different from the entrance aperture of the transmission direction due to propagation-direction-dependent operations in the optical channels.

According to another aspect of the invention, there is provided a measuring apparatus. The measuring apparatus is configured to transmit an optical beam towards an object in a transmission direction through the optical element, and to receive an optical beam reflected from the object in a reception direction through the optical element. The optical element includes a beam transformer having an entrance aperture of the transmission direction, a common two-directional aperture for an exit in the transmission direction and for an entrance in the reception direction, and an exit aperture of the reception direction. The beam transformer is configured to form at least two internal optical channels supporting different plane-polarization directions, the internal optical channels being common to the transmission and reception direction and at least two non-reciprocal components for propagation-direction-dependent polarization operations, and in the transmission direction. The beam transformer is configured to split the optical beam input through the entrance aperture of the transmission direction into plane-polarized beams and to pass the plane-polarized beams to the optical channels. The at least two non-reciprocal components, one for each plane polarized beam in the optical channels, are configured to perform a first propagation-direction-dependent operation on the plane-polarized beams. The beam transformer is configured to combine the optical beams from the optical channels into a transmission beam and to transmit the transmission beam through the common aperture; and in the reception direction. The beam transformer is configured to split the optical beam received through the common aperture into plane-polarized beams and to pass the plane-polarized beams to the optical channels. Each non-reciprocal component is configured to perform a second propagation-direction-dependent operation on the plane-polarized beams in the optical channels. The beam transformer is configured to combine the plane-polarized beams from the optical channels into one received optical beam, and to output the received optical beam through the exit aperture of the reception direction different from the entrance aperture of the transmission direction due to propagation-direction-dependent operations in the optical channels.

According to another aspect of the invention, there is provided a method for measuring including transmitting, by a measuring apparatus, an optical beam towards an object in a transmission direction through the optical element. This is accomplished by splitting the optical beam input through the entrance aperture of transmission direction into plane-polarized beams, and passing the plane-polarized beams to internal optical channels by the beam transformer. The internal optical channels being common to the transmission and the reception directions. A first propagation-direction-dependent operation is performed on the optical beam by at least two non-reciprocal component, one in each optical channel. The optical beams are combined from the optical channels into a transmission beam and transmits the transmission beam through the common aperture, by the beam transformer. The optical beam is reflected from the object in a reception direction through the optical element. Receiving includes splitting the optical beam received through the common aperture into plane-polarized beams, and passing the plane-polarized beams to the optical channels by the beam transformer. A second propagation-direction-dependent operation is performed on the plane-polarized beams in the optical channels by each non-reciprocal component. The plane-polarized beams from the optical channels are combined into one received beam. The received beam is passed through the exit aperture of the reception direction by the beam transformer. The exit aperture of the reception direction is different from the entrance aperture of the transmission direction due to propagation-direction-dependent operations in the optical channels.

The invention provides several advantages. The loss of optical power can be minimized and the coverage areas of transmission and reception can be matched completely. A simple optical system can be used resulting in a small measuring head.

### BRIEF DESCRIPTION OF THE FIGURES

In the following, the invention will be described in greater detail with reference to the embodiments and the accompanying drawings, in which

FIG. 1 shows an optical element;

FIG. 2 illustrates an optical element with beam transformers,

FIG. 3A illustrates an optical element with beam splitters in operation in a transmission direction,

FIG. 3B illustrates an optical element with beam splitters in operation in a reception direction,

FIG. 4 illustrates a non-reciprocal component,

FIG. 5 illustrates a measuring apparatus,

FIG. 6 illustrates a measuring apparatus with optical fibers,

FIG. 7 illustrates a flow chart of the method in the transmission direction, and

FIG. 8 illustrates a flow chart of the method in the reception direction.

### DETAILED DESCRIPTION OF THE INVENTION

FIG. 1 illustrates a general overview of an optical element for a measuring apparatus. The optical element 100 can be considered non-reciprocal which means that the operation of the optical element 100 depends on the optical beam's propagation direction through the optical element 100.

The measuring apparatus may transmit the optical beam towards an object 102 in a transmission direction through the optical element 100 and the measuring apparatus may receive an optical beam reflected from the object 102 in a reception direction through the optical element 100. The optical element 100 may be a part of a measuring head of the measuring apparatus. In the present application, the optical beam refers to electromagnetic radiation at wavelengths including but not limited to about several hundred nanometers. The transmission direction means a direction from an optical source 104 to the object 102 and the reception direction means a direction from the object 102 to the optical source 104 which may transmit the optical beam as optical beams.

The optical element 100 may include a beam transformer 106 and at least two non-reciprocal components 108 and 110.

One non-reciprocal component can include a physical component pair like a Faraday rotator and a quarter wave plate.

One non-reciprocal component is regarded as having only one optical pathway. However, the at least two non-reciprocal components may include one physical component pair having two spatially separated optical pathways.

The beam transformer 106 has an entrance aperture 112 in the transmission direction and a common two-directional aperture 114 for an exit in the transmission direction and for an entrance in the reception direction. The common aperture 114 for exit and entrance results in co-axial optical operation in the measuring apparatus. The non-reciprocity of the optical element 100 which means in this application a propagation-direction-dependent operation manifests itself such that an entrance aperture 112 of the transmission direction and an exit aperture 116 of the reception direction which is for outputting the received beam to a stop detector 118 are physically separate, although the exit to the object and the entrance from the object are the same. The arrows in FIG. 1 illustrate the propagation of the optical beam.

A non-reciprocal component can also include two separate pathways

The propagation-direction-dependent operation can be achieved by at least two non-reciprocal components 108 and 110 which may include but is not limited to, for example, a Faraday rotator. Additionally, the measuring apparatus may include a variety of other optical components including, but not limited to, filters, lenses, mirrors, fibers and the like.

When propagating through the optical element 100 in the transmission direction, the beam transformer 106 forms at least two internal optical channels 120 supporting different plane-polarization directions. The internal optical channels 120 are common for the transmission and reception directions.

The beam transformer 106 may split the optical beam from the entrance aperture 112 of the transmission direction into plane-polarized beams and pass the plane-polarized beams to the internal optical channels 120, one plane-polarized beam in one optical channel.

Each non-reciprocal component 108 and 110 may perform a first propagation-direction-dependent operation on the plane-polarized beams. The number of the non-reciprocal components 108 and 110 and the number of the internal optical channels 120 are the same, and one internal optical channel 120 may be provided with one non-reciprocal component 108 and 110.

The beam transformer 106 may combine the plane-polarized beams from the optical channels into a transmission beam and transmit the transmission beam through the common aperture 114 towards the object.

When propagating through the optical element 100 in the reception direction, the beam transformer 106 may split the optical beam received through the common aperture 114 into plane-polarized beams and pass the plane-polarized beams to the internal optical channels 120, one plane-polarized beam in one optical channel. In this propagation direction, each non-reciprocal component 108 and 110 may perform a second propagation-direction-dependent operation on the plane-polarized beam in the internal optical channels 120. One optical channel 120 may be provided with one non-reciprocal component 108 and 110.

The beam transformer 106 may combine the plane-polarized beams from the internal optical channels 120 into one received optical beam, and output the received optical beam through the exit aperture 116 of the reception direction. The exit aperture 116 is different from the entrance aperture 112 of the transmission direction due to propagation-direction-dependent operations in the internal optical channels 120.

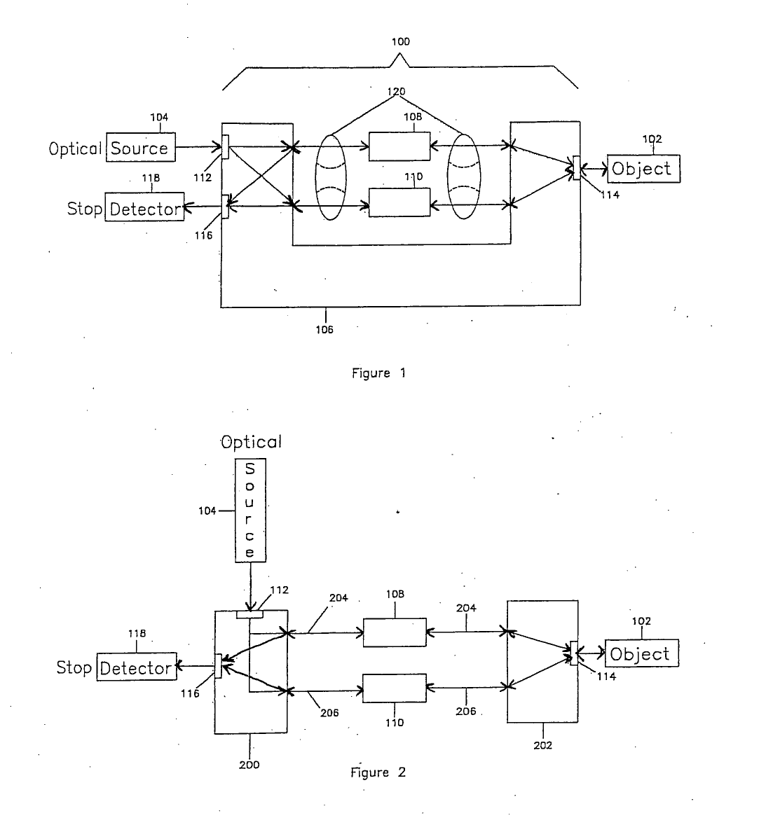

The beam transformer may include two polarization transformers 200 and 202 as shown in FIG. 2. The first polarization transformer 200 may have the entrance aperture 112 of the transmission direction and a separate exit aperture 116 of the reception direction. The second polarization transformer 202 may have a common two-directional aperture 114 for transmission and reception directions.

When propagating through the optical element 100 in the transmission direction, there is a first polarization transformer 200 and a second polarization transformer 202 that may form two optical channels of different plane-polarization directions between the two polarization transformers 200 and 202. The first polarization transformer 200 may split the optical beam input through the entrance aperture 112 into plane-polarized beams and pass the plane-polarized beams into the optical channels 204 and 206, one plane-polarized beam in one channel. The polarization directions of the plane-polarized beams may be orthogonal or close to orthogonal.

The two non-reciprocal components 108 and 110 may perform a first propagation-direction-dependent operation on the two plane-polarized beams by either turning the polarization direction of the optical beam or preserving the polarization direction of the optical beam. One optical channel is provided with one non-reciprocal component.

The second polarization transformer 202 may combine the plane-polarized beams from the optical channels into a transmission beam and transmit the optical beam from the optical channels through the common aperture 114.

When propagating through the optical element 100 in the reception direction, the second polarization transformer 202 may split the optical beam received through the common aperture 114 into two plane-polarized beams and pass the plane-polarized beams to the two optical channels 204 and 206. The polarization directions of the plane-polarized beams may be orthogonal or close to orthogonal.

The two non-reciprocal components 108 and 110 may perform a second propagation-direction-dependent operation on the plane-polarized beams by either preserving the polarization direction of the plane-polarized beams or turning the polarization direction of the plane-polarized beams. Whichever way the first and second operation may be performed, the first and the second propagation-direction-dependent operations should be opposite to each other.

The first polarization transformer 200 may combine the plane-polarized beams from the two optical channels 204 and 206 into a received beam, and output the received beam through the exit aperture 116 of the reception direction.

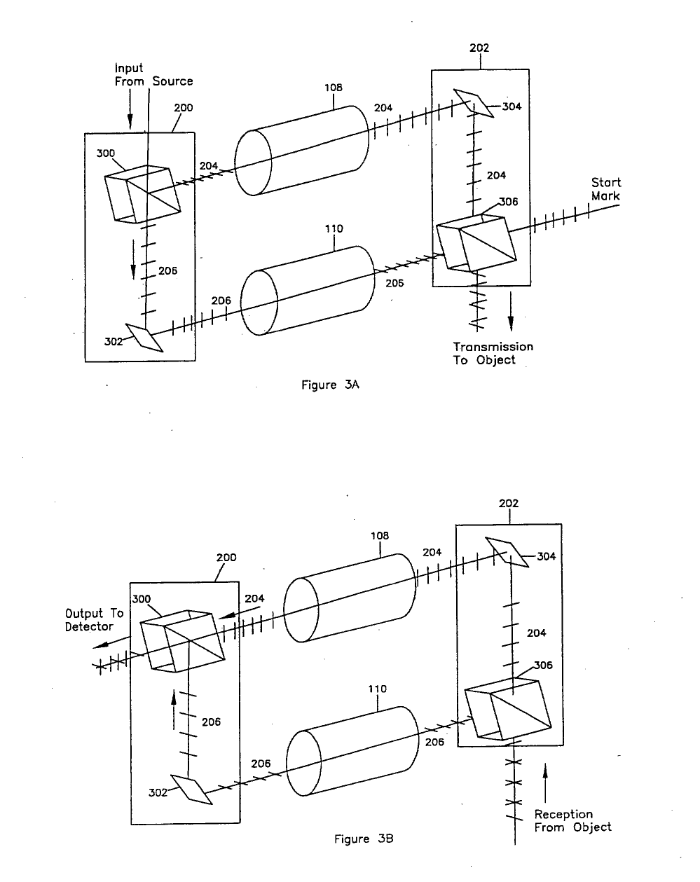

FIGS. 3A and 3B illustrate the optical element 100 utilizing Faraday rotator, quarter wave plate, polarizing beam splitters and mirrors. FIG. 3A represent an example of operation in the transmission direction and FIG. 3B represent a corresponding example of operation in the reception direction. The optical element 100 may include two non-reciprocal components 108 and 110, the first non-reciprocal component 108 in the first optical channel 204 and the second non-reciprocal component 110 in the second optical channel 206.

The first polarization transformer 200 may include a first polarizing beam splitter 300 and a first mirror 302, and the second polarization transformer 202 may include a second polarizing beam splitter 306 and a second mirror 304.

When propagating through the optical element 100 in the transmission direction, the first polarizing beam splitter 300 may split the optical beam into two orthogonally plane-polarized beams, pass a first plane-polarized beam into a first optical channel 204, and pass a second plane-polarized beam to the first mirror 302 which reflects the second plane-polarized beam to a second optical channel 206.

The two non-reciprocal components 108 and 110 perform the first propagation-direction-dependent operation on the optical beam.

The second mirror 304 may reflect the first plane-polarized beam to the second polarizing beam splitter 306 which combines the plane-polarized beams from the optical channels 204 and 206 into the transmitted optical beam for transmitting the transmitted optical beam through the common aperture 114.

When propagating through the optical element 100 in the reception direction, the second polarizing beam splitter 306 may split the optical beam from the common aperture 114 into two orthogonally plane-polarized beams, pass a first plane-polarized beam into a second optical channel 206, and pass a second plane-polarized beam to the second mirror 304 configured to reflect the second plane-polarized beam to the first beam splitter 300 through a first optical channel 204.

The two non-reciprocal components 108 and 110 may perform the second propagation-direction-dependent operation on the optical beam. The first propagation-direction-dependent operation and the second propagation-direction-dependent operation may have a mutually opposed effect.

The first mirror 302 may reflect the second plane-polarized beam to the first polarizing beam splitter 300 which may combine the plane-polarized beams from the optical channels 204 and 206 into a received optical beam for outputting the received optical beam through the exit aperture 116 of the reception direction. The mirrors 302 and 304 may be mirrors or prisms.

The non-reciprocal components 108 and 110 in the optical channels may preserve the polarization direction of the plane-polarized beam as the first propagation-direction-dependent operation, and may turn the polarization direction of the plane-polarized beam as the second propagation-direction-dependent operation. Hence, the non-reciprocal components 108 and 110 may perform no rotation to the polarization direction when the optical beam propagates in the transmission direction but may rotate the polarization direction when the optical beam propagates in the reception direction.

Alternatively, the non-reciprocal components in the optical channels 108 and 110 may turn the polarization direction of the plane-polarized beam as the first propagation-direction-dependent operation, and may preserve the polarization direction of the plane-polarized beam as the second propagation-direction-dependent operation. Hence, the non-reciprocal components 108 and 110 may rotate in the polarization direction when the optical beam propagates in the transmission direction but may perform no rotation in the polarization direction when the optical beam propagates in the reception direction.

The polarization direction of the optical beam of the transmission direction in the first channel 204 between the first polarizing beam splitter 300 and the non-reciprocal component 108 is different from the polarization direction of the optical beam of the reception direction in the first channel 204 between the first polarizing beam splitter 300 and the non-reciprocal component 108. In FIG. 3A the polarization directions (marked with short lines) of the optical beam can be seen in the transmission direction. Similarly, the polarization direction of the optical beam of the transmission direction in the second channel 206 between the first polarizing beam splitter 300 and the non-reciprocal component 110 may be different from the polarization direction of the optical beam of the reception direction in the second channel 206 between the first polarizing beam splitter 300 and the non-reciprocal component 110. In FIG. 3B the polarization directions (marked with short lines) of the optical beam can be seen in the reception direction. The difference between the polarization directions should be orthogonal, i.e. 90 degrees, as a minimum power loss in the optical element 100 is desired. Because of the difference between the polarization directions, the first beam splitter 300 separates the entrance aperture of the transmission direction and the exit aperture of the reception direction.

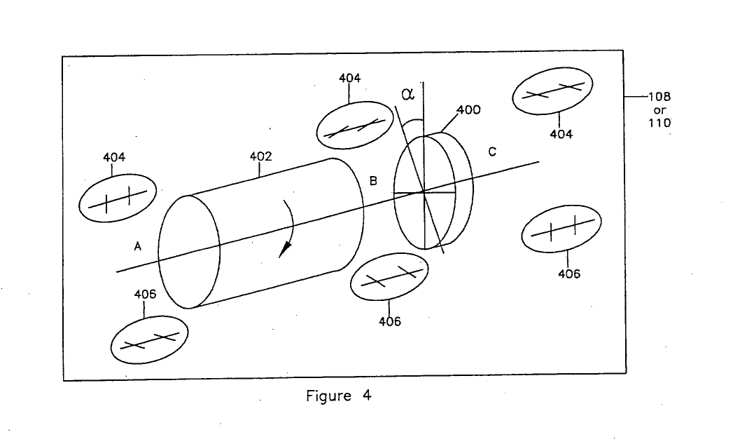

FIG. 4 illustrates an example of a non-reciprocal component. Each non-reciprocal component 108 and 110 may be implemented by combining a quarter-wave component 400 configured to turn a polarization direction by 45 degrees independently of the propagation direction, and a non-reciprocal rotator 402 configured to turn a polarization direction by 45 degrees depending on the propagation direction. FIG. 4 illustrates polarization directions (404, 406) before, in and after (locations A, B, and C) the non-reciprocal component. The examples 404 may relate to the transmission direction and the examples 406 may relate to the reception direction or vice versa. The structural order of the quarter-wave component 400 and the non-reciprocal rotator 402 may be reversed. The quarter-wave component 400 may be a quarter-wave plate made of a birefringent crystal which forms a phase difference of one-quarter wavelength between the ordinary and the extraordinary rays of the optical beam propagating through the plate. The angle α, of the quarter-wave component 400, should be adjusted properly with respect to its lattice directions.

The operation of the non-reciprocal rotator 402 may be based on magnetic rotation of a polarization direction of a plane-polarized beam known also as Kundt effect or Faraday rotation. When a magnetic field parallel to the propagation direction of the optical beam penetrates a magneto-optic material, the polarization direction of a plane-polarized optical beam rotates in the material. The rotation angle Φ of the polarization direction depends, for instance, on magnetic field strength H, distance L the optical beam travels in the magneto-optic material, and a Verdet constant V of the magneto-optic material. The angle Φ of rotation can, thus, be defined in a non-constant magnetic field by

$$Φ = V {\int }_{0}^{L} H ⅆ l ,$$

where l is a distance variable and dl is a differential distance. In a constant magnetic field, the equation may simply be written as Φ=VHL, i.e. the rotation angle is a product of the Verdet constant V, the constant magnetic field strength H and the thickness of the magneto-optic material L. The rotation direction of the non-reciprocal rotator 402 is shown with an arrow in FIG. 4.

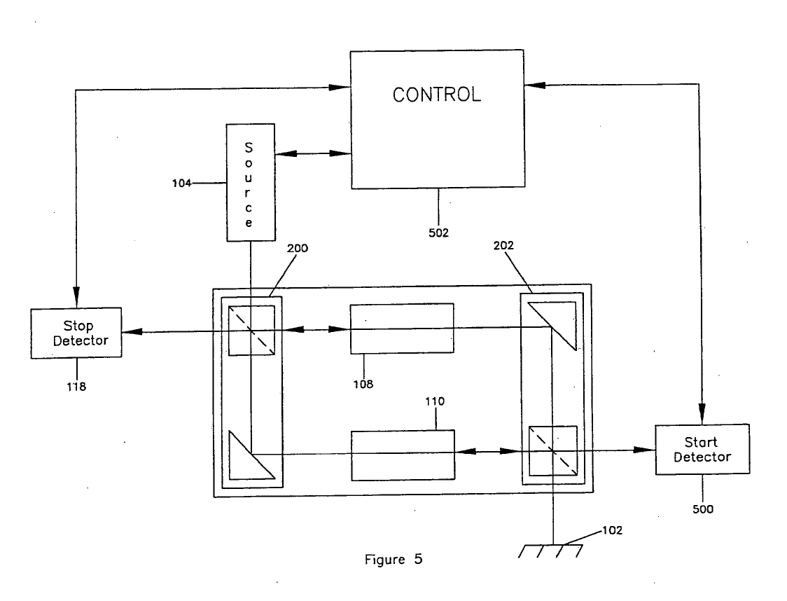

FIG. 5 illustrates a measuring apparatus based on a time-of-flight principle. The optical beam may be transmitted from an optical source 104 to the entrance aperture of the transmission direction in the optical element 100. The source 104 may be a monochromatic optical source including, but not limited to, a laser, a narrow band optical source such as a LED (Light Emitting Diode) or a wideband optical source such as a glow lamp, an incandescent lamp, a halogen lamp, and the like. The optical beam may travel through the optical element 100 to the second polarization transformer 202 which may penetrate a fraction of the optical beam such that the fraction passes to a start detector 500. The fraction of the optical beam may be due to imperfections in the second transformer and in polarization. Hence, there is no need to construct the second transformer such that it penetrates a certain part of the optical beam although that may also be done. The start detector 500 detects the fraction which may vary from some percentages to a billionth part (or even smaller) in power of the beam entering the entrance aperture and feeds a corresponding electrical signal to a control unit 502 which forms a start mark t₁ for the pulse of the optical beam. The start mark t₁ defines the moment relating to the departure of the optical beam from the optical element 100. Instead of the position relating to the polarizing beam splitter in the second polarization transformer 202, the start detector 500 may be placed beside mirrors of either polarization transformers 200, 202 (the detectors drawn with a dashed line).

The majority of the optical beam is transmitted to the object 102 which reflects a part of the optical beam back to the optical element 100. The amount of reflection being based on the properties of the target surface. The optical element 100 passes the received optical beam to a stop detector 118. As the measuring apparatus may be suitable for measuring hot surfaces and objects with high absorption properties without possibility of attaching reflectors restricting to the object, the object 102 may be a hot steel-processing vessel such as a ladle or a converter. The present solution is not, however, restricted to these vessels. The stop detector 118 detects the received optical beam and feeds a corresponding electrical signal to a control unit 502 which forms a stop mark t₂ for the pulse of the received optical beam. The stop mark t₂ defines the moment relating to the arrival of the optical beam to the measuring apparatus. The control unit 502 may determine timing difference Δt=t₂−t₁ of the start mark and the stop mark and the control unit 502 may determine the distance D between the object 102 and the measuring apparatus as a function of the timing difference, D=f(Δt). Generally, the dependence between the distance D and the timing difference Δt is linear, i.e. D=cΔt, where c is a constant. In the case of the object 102 being a hot steel-processing vessel, the changes in the thickness of the wall of the vessel can be measured as the wall wears, which can be observed by the increase in distance.

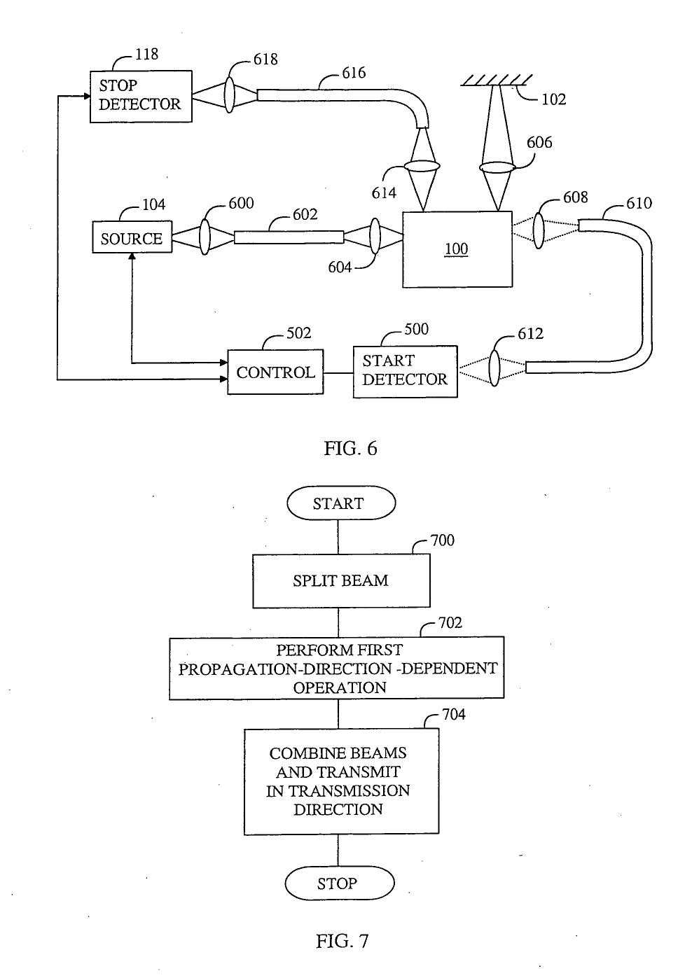

FIG. 6 represents a measuring apparatus utilizing optical fibers. The optical beam from the optical source 104 may be focused in a transmitting fiber 602 by a first optical unit 600. The optical beam leaving the transmitting fiber 602 may be focused to an entrance aperture of the optical element 100 by a second optical unit 604. The optical beam transmitted from the optical element 100 may be focused or collimated towards the object 102 by a third optical unit 606. The optical beam penetrating towards the start detector 500 may be focused to a start fiber 610 by a fourth optical unit 608. The start pulse propagating out of the start fiber 610 may be focused to the start detector 500 by a fifth optical unit 612. The received optical beam reflected from the object may be focused to a receiving fiber 616 by a sixth optical unit 614. Finally, the received optical beam leaving the receiving fiber 616 may be focused to the stop detector 118 by a seventh optical unit 618. The optical units from the first to the seventh may include at least one lens for focusing or collimating the optical beam. Additionally, any of the optical units may include optical filters for limiting the optical band. A proper optical band may be important in the reception direction.

The measuring apparatus has several advantages because of the optical element 100. The measurement range or the range of optimum signal or the range of maximum signal-to-noise ratio is not limited to common overlapping coverage areas of transmission and reception. The loss of optical power is minimal and theoretically much less than in a conventional measurement. A better measurement accuracy can be obtained using the present invention than with a two-axial measurement. In addition to problems mentioned already, the distribution of a laser beam is inhomogeneous transversally and longitudinally. Therefore, the effect combined with the variation of target emissivity is extremely difficult to compensate in a two-axial measurement. The present solution avoids the problem completely. The present solution also enables the use of telecentric optics, thus, relieving problems related to distance dependent aberrations in transmission and reception.

FIG. 7 illustrates a flow chart of the method relating to a transmission direction from START to STOP. In step 700, the optical beam input through the entrance aperture of the transmission direction is split into plane-polarized beams, and passing the plane-polarized beams to internal optical channels by the beam transformer, the internal optical channels being common to the transmission and the reception directions. In step 702, a first propagation-direction-dependent operation is performed on the optical beam by at least two non-reciprocal components, one in each optical channel. In step 704, optical beams from the optical channels are combined into a transmission beam and transmitting the transmission beam through the common aperture, by the beam transformer.

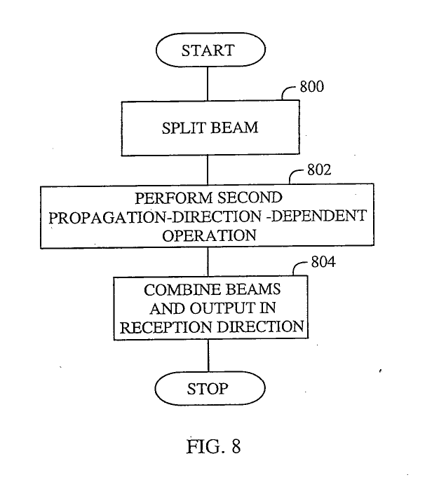

FIG. 8 illustrates a flow chart of method relating to a reception direction. In step 800, the optical beam received through the common aperture is split into plane-polarized beams, and the plane-polarized beams are passed to the optical channels by the beam transformer. In step 802, a second propagation-direction-dependent operation is performed on the plane-polarized beams in the optical channels by each non-reciprocal component. In step 804, the plane-polarized beams are combined from the optical channels into one received beam, and the received beam is output through the exit aperture of the reception direction by the beam transformer, the exit aperture of the reception direction being different from the entrance aperture of the transmission direction due to propagation-direction-dependent operations in the optical channels.

Even though the invention is described above with reference to examples according to the accompanying drawings, it is clear that the invention is not restricted thereto but can be modified in several ways within the scope of the appended claims.

1. An optical element for a measuring apparatus configured to transmit an optical beam towards an object in a transmission direction through the optical element, and to receive an optical beam reflected from the object in a reception direction through the optical element, wherein the optical element comprises:
a beam transformer having an entrance aperture of the transmission direction, a common two-directional aperture for an exit in the transmission direction and for an entrance in the reception direction, and an exit aperture of the reception direction, and the beam transformer is configured to form at least two internal optical channels supporting different plane-polarization directions, the internal optical channels being common to the transmission and reception directions,
at least two non-reciprocal components for propagation-direction-dependent polarization operations, and in the transmission direction,
the beam transformer is configured to split the optical beam input through the entrance aperture of the transmission direction into plane-polarized beams and to pass the plane-polarized beams to the optical channels,
the at least two non-reciprocal components, one for each plane polarized beam in the optical channels, are configured to perform a first propagation-direction-dependent operation on the plane-polarized beams,
the beam transformer is configured to combine the optical beams from the optical channels into a transmission beam and to transmit the transmission beam through the common aperture; and in the reception direction,
the beam transformer is configured to split the optical beam received through the common aperture into plane-polarized beams and to pass the plane-polarized beams to the optical channels,
each non-reciprocal component is configured to perform a second propagation-direction-dependent operation on the plane-polarized beams in the optical channels, and
the beam transformer is configured to combine the plane-polarized beams from the optical channels into one received optical beam, and to output the received optical beam through the exit aperture of the reception direction different from the entrance aperture of the transmission direction due to propagation-direction-dependent operations in the optical channels.

2. The optical element of claim 1, wherein the beam transformer comprises a first polarization transformer and a second polarization transformer, wherein
the first polarization transformer has the entrance aperture of the transmission direction and the exit aperture of the reception direction;
the second polarization transformer has the common two-directional aperture for transmission and reception directions; and in the transmission direction
the polarization transformers are configured to form the at least two optical channels supporting different plane-polarization directions between the polarization transformers;
the first polarization transformer is configured to split the optical beam input through the entrance aperture of the transmission direction into plane-polarized beams, and to pass the plane-polarized beams to the optical channels;
the second polarization transformer is configured to combine the optical beams from the optical channels into a transmission beam and to transmit the transmission beam through the common aperture; and in the reception direction
the second polarization transformer is configured to split the optical beam received through the common aperture into plane-polarized beams, and to pass the plane-polarized beams to the optical channels; and
the first polarization transformer is configured to combine the plane-polarized beams from the optical channels into a received beam, and to output the received beam through the exit aperture of the reception direction.

3. The optical element of claim 2, wherein the optical element comprises two non-reciprocal components, one in each of the two optical channels;
the first polarization transformer comprises a first polarizing beam splitter and a first mirror, and the second polarization transformer comprises a second polarizing beam splitter and a second mirror, and in the transmission direction the first polarizing beam splitter is configured to split the optical beam into two orthogonally plane-polarized beams, to pass a first plane-polarized beam into a first optical channel, and to pass a second plane-polarized beam to the first mirror configured to reflect the second plane-polarized beam to a second optical channel;
the second mirror is configured to reflect the first plane-polarized beam to the second polarizing beam splitter, and
the second polarizing beam splitter is configured to combine the plane-polarized beams from the optical channels into the transmitted optical beam for transmitting the transmitted optical beam through the common aperture; and in the reception direction
the second polarizing beam splitter is configured to split the optical beam from the common aperture into two orthogonally plane-polarized beams, to pass a first plane-polarized beam into a second optical channel and to pass a second plane-polarized beam to the second mirror configured to reflect the second plane-polarized beam to a first optical channel;
the first mirror is configured to reflect the second plane-polarized beam to the first polarizing beam splitter, and
the first polarizing beam splitter is configured to combine the plane-polarized beams from the optical channels into a received optical beam for outputting the received optical beam through the exit aperture of the reception direction.

4. The optical element of claim 3, wherein the two non-reciprocal components in the common optical channels are configured to preserve the polarization direction of the plane-polarized beam as the first propagation-direction-dependent operation, and the two non-reciprocal components in the common optical channels are configured to turn the polarization direction of the plane-polarized beam as the second propagation-direction-dependent operation.

5. The optical element of claim 3, wherein the two non-reciprocal components in the common optical channels are configured to turn the polarization direction of the plane-polarized beam as the first propagation-direction-dependent operation, and the two non-reciprocal components in the common optical channels are configured to preserve the polarization direction of the plane-polarized beam as the second propagation-direction-dependent operation.

6. The optical element of claim 1, wherein each non-reciprocal component comprises a quarter-wave component configured to turn a polarization direction by 45 degrees plus or minus 90 degrees independently of the propagation direction, and a non-reciprocal rotator configured to turn a polarization direction by 45 degrees depending on the propagation direction.

7. A measuring apparatus, the measuring apparatus configured to transmit an optical beam towards an object in a transmission direction through the optical element, and to receive an optical beam reflected from the object in a reception direction through the optical element, wherein the optical element comprises:
a beam transformer having an entrance aperture of the transmission direction, a common two-directional aperture for an exit in the transmission direction and for an entrance in the reception direction, and an exit aperture of the reception direction, and the beam transformer is configured to form at least two internal optical channels supporting different plane-polarization directions, the internal optical channels being common to the transmission and reception direction,
at least two non-reciprocal components for propagation-direction-dependent polarization operations, and in the transmission direction,
the beam transformer is configured to split the optical beam input through the entrance aperture of the transmission direction into plane-polarized beams and to pass the plane-polarized beams to the optical channels,
the at least two non-reciprocal components, one for each plane polarized beam in the optical channels, are configured to perform a first propagation-direction-dependent operation on the plane-polarized beams,
the beam transformer is configured to combine the optical beams from the optical channels into a transmission beam and to transmit the transmission beam through the common aperture; and in the reception direction,
the beam transformer is configured to split the optical beam received through the common aperture into plane-polarized beams and to pass the plane-polarized beams to the optical channels,
each non-reciprocal component is configured to perform a second propagation-direction-dependent operation on the plane-polarized beams in the optical channels, and
the beam transformer is configured to combine the plane-polarized beams from the optical channels into one received optical beam, and to output the received optical beam through the exit aperture of the reception direction different from the entrance aperture of the transmission direction due to propagation-direction-dependent operations in the optical channels.

8. The measuring apparatus of claim 7, wherein the beam transformer comprises a first polarization transformer and a second polarization transformer, and
the first polarization transformer has the entrance aperture of the transmission direction and the exit aperture of the reception direction;
the second polarization transformer has the common two-directional aperture for transmission and reception directions; and in the transmission direction
the polarization transformers are configured to form the at least two optical channels supporting different plane-polarization directions between the polarization transformers;
the first polarization transformer is configured to split the optical beam input through the entrance aperture of the transmission direction into plane-polarized beams, and to pass the plane-polarized beams to the optical channels;
the second polarization transformer is configured to combine the optical beams from the optical channels into a transmission beam and to transmit the transmission beam through the common aperture; and in the reception direction
the second polarization transformer is configured to split the optical beam received through the common aperture into plane-polarized beams, and to pass the plane-polarized beams to the optical channels; and
the first polarization transformer is configured to combine the plane-polarized beams from the optical channels into a received beam, and to output the received beam through the exit aperture of the reception direction.

9. The measuring apparatus of claim 8, wherein the optical element comprises two non-reciprocal components, one in each of the two optical channels;
the first polarization transformer comprises a first polarizing beam splitter and a first mirror, and the second polarization transformer comprises a second polarizing beam splitter and a second mirror; and in the transmission direction
the first polarizing beam splitter is configured to split the optical beam into two orthogonally plane-polarized beams, to pass a first plane-polarized beam into a first optical channel, and to pass a second plane-polarized beam to the first mirror configured to reflect the second plane-polarized beam to a second optical channel;
the second mirror is configured to reflect the first plane-polarized beam to the second polarizing beam splitter, and
the second polarizing beam splitter is configured to combine the plane-polarized beams from the optical channels into the transmitted optical beam for transmitting the transmitted optical beam through the common aperture; and in the reception direction
the second polarizing beam splitter is configured to split the optical beam from the common aperture into two orthogonally plane-polarized beams, to pass a first plane-polarized beam into a second optical channel and to pass a second plane-polarized beam to the second mirror configured to reflect the second plane-polarized beam to a first optical channel;
the first mirror is configured to reflect the second plane-polarized beam to the first polarizing beam splitter, and
the first polarizing beam splitter is configured to combine the plane-polarized beams from the optical channels into a received optical beam for outputting the received optical beam through the exit aperture of the reception direction.

10. The measuring apparatus of claim 9, wherein the two non-reciprocal components in the common optical channels are configured to preserve the polarization direction of the plane-polarized beam as the first propagation-direction-dependent operation, and the two non-reciprocal components in the common optical channels are configured to turn the polarization direction of the plane-polarized beam as the second propagation-direction-dependent operation.

11. The measuring apparatus of claim 9, wherein the two non-reciprocal components in the common optical channels are configured to turn the polarization direction of the plane-polarized beam as the first propagation-direction-dependent operation, and the two non-reciprocal components in the common optical channels are configured to preserve the polarization direction of the plane-polarized beam as the second propagation-direction-dependent operation.

12. The measuring apparatus of claim 7, wherein the measuring apparatus comprises an optical source and optical fibers, the optical fibers being configured to input an optical beam from the optical source to the optical element in the transmission direction and to receive an optical beam output from the optical element for supplying the optical beam for detection.

13. The measuring apparatus of claim 7, wherein the measuring apparatus comprises a control unit, a start detector and a stop detector which are operationally coupled to the control unit, and the optical source is configured to transmit the optical beam as an optical beamoptical beam, the control unit is configured to;
form a start mark at a moment the optical beam departs from the optical element in the transmission direction detected by the start detector,
form a stop mark at a moment the optical beam arrives in the optical element in the reception direction detected by the stop detector, and
determine a distance corresponding to the time difference between the stop mark and the start mark.

14. The measuring apparatus of claim 13, wherein the measuring apparatus is configured to measure a property of a hot-steel processing vessel as a function of the distance determined.

15. The measuring apparatus of claim 9, wherein each non-reciprocal component comprises a quarter-wave component configured to turn a polarization direction by 45 plus or minus 90 degrees independent of the propagation direction, and a non-reciprocal rotator configured to turn a polarization direction by 45° depending on the propagation direction.

16. A measuring method, the method comprising:
transmitting, by a measuring apparatus, an optical beam towards an object in a transmission direction through the optical element wherein the transmitting comprises
splitting the optical beam input through the entrance aperture of transmission direction into plane-polarized beams, and passing the plane-polarized beams to internal optical channels by the beam transformer, the internal optical channels being common to the transmission and the reception directions,
performing a first propagation-direction-dependent operation on the optical beam by at least two non-reciprocal component, one in each optical channel
combining optical beams from the optical channels into a transmission beam and transmitting the transmission beam through the common aperture, by the beam transformer;
receiving, by the measuring apparatus, an optical beam reflected from the object in a reception direction through the optical element, wherein the receiving comprises;
splitting the optical beam received through the common aperture into plane-polarized beams, and passing the plane-polarized beams to the optical channels by the beam transformer,
performing a second propagation-direction-dependent operation on the plane-polarized beams in the optical channels by each non-reciprocal component,
combining the plane-polarized beams from the optical channels into one received beam, and outputting the received beam through the exit aperture of the reception direction by the beam transformer, the exit aperture of the reception direction being different from the entrance aperture of the transmission direction due to propagation-direction-dependent operations in the optical channels.

17. The measuring method of claim 16, wherein:
the beam transformer comprises a first polarization transformer, and a second polarization transformer,
the first polarization transformer has an entrance aperture of the transmission direction and an exit aperture of the reception direction;
the second polarization transformer has a common two-directional aperture for transmission and reception directions; and the transmitting further comprises;
splitting the optical beam from the entrance aperture of transmission direction into plane-polarized beams and passing the plane-polarized beams into the optical channels by the first polarization transformer,
combining the optical beams from the optical channels into a transmission beam and transmitting the transmission beam from the at least one common optical channel through the common aperture, by the second polarization transformer; and the receiving further comprising
splitting the optical beam from the two-directional aperture into plane-polarized beams and passing the plane-polarized beams to the at least two optical channels by the second polarization transformer,
combining the plane-polarized beams into a received beam from the at least two optical channels and outputting the received beam through the exit aperture of the reception direction different from the entrance aperture of the transmission direction by the first polarization transformer.

18. The measuring method of claim 17, wherein the optical element comprises two non-reciprocal components, one in each of the two optical channels;
the first polarization transformer comprises a first polarizing beam splitter and a first mirror, and the second polarization transformer comprises a second polarizing beam splitter and a second mirror, the transmitting method further comprises;
splitting the optical beam into two orthogonally plane-polarized beams, passing a first plane-polarized beam into a first optical channel and passing a second plane-polarized beam to the first mirror by the first polarizing beam splitter,
reflecting the second plane-polarized beam to a second optical channel by the first mirror;
reflecting the first plane-polarized beam in the first optical channel towards the second polarizing beam splitter by the second mirror, and
combining the plane-polarized beams from the optical channels into a transmitted optical beam for transmitting the transmitted optical beam through the common aperture by the second polarizing beam splitter; the receiving method further comprising
splitting the optical beam from the common aperture into two orthogonally plane-polarized beams, passing a first plane-polarized beam to the second mirror and passing a second plane-polarized beam into a second optical channel by the second polarizing beam splitter,
reflecting the first plane-polarized beam to the first optical channel by the second mirror,
reflecting the second plane-polarized beam in the second optical channel towards the first polarizing beam splitter by the first mirror, and
combining the plane-polarized beams from the optical channels into a received optical beam for outputting the received optical beam through the exit aperture of the reception direction by the first polarizing beam splitter.

19. The measuring method of claim 18, wherein the method further comprises performing the first propagation-direction-dependent operation by preserving the polarization direction of the plane-polarized beam in each optical channel, and performing the second propagation-direction-dependent operation by turning the polarization direction of the plane-polarized beam in each optical channel.

20. The measuring method of claim 18, wherein the method further comprises performing the first propagation-direction-dependent operation by turning the polarization direction of the plane-polarized beam in each optical channel, and performing the second propagation-direction-dependent operation by preserving the polarization direction of the plane-polarized beam in each optical channel.

21. The measuring method of claim 16, wherein the method further comprises an optical source and optical fibers, the optical fibers being configured to input an optical beam from the optical source to the optical element in the transmission direction and to receive an optical beam output from the optical element for supplying the optical beam for detection.

22. The measuring method of claim 16, wherein the method further comprises transmitting the optical beam as an optical beam by an optical source, and
forming a start mark at the moment the optical beam departs from the optical element in the transmission direction detected by the start detector, and
forming a stop mark at a moment the optical beam arrives in the optical element in the reception direction detected by the stop detector, and
determining a distance corresponding to the time difference between the stop mark and the start mark by a control unit.

23. The measuring method of claim 22, wherein the method further comprises measuring a property of a hot-steel processing vessel as a function of the distance determined.

24. The measuring method of claim 16, wherein the method further comprises performing propagation-direction-dependent operations by turning a polarization direction by 45 degrees plus or minus 90 degrees independently of the propagation direction by a quarter-wave component included in each non-reciprocal component and turning a polarization direction by 45° depending on the propagation direction by a non-reciprocal rotator included in each non-reciprocal component.
